(19) United States
(12) Patent Application Publication
(10) Pub. No.: US 2007/0101604 A1
(43) Pub. Date: May 10, 2007

(54) Radio/CD player drying hood

(76) Inventor: Yuvonne English Brazier, Mobile, AL (US)

Correspondence Address: Yuvonne E. Brazier, P. O. Box 40604, Mobile, AL, 36640-0604, US

(21) Appl. No.: 11/518,621

(22) Filed: May 9, 2005

(51) Int. Cl. F26B 19/00; A45D 20/12

(52) U.S. Cl. 34/96; 34/90

(57) ABSTRACT

A hair dryer's hood that contain a compact disc player along with a radio to entertain while one is getting their hair dry. The hood would be made of plastic and would contain three to four speakers to create a surround sound atmosphere. The radio/compact disc player would be fitted in the armrest of a salon chair, or the base of a portable unit.

### BACKGROUND OF THE INVENTION

1. Field of the Invention

Radio/CD Player Drying Hood, would provide an innovative entertainment system designed to provide entertainment for a customer in a salon chair. It would be ideal for hairstyling salons and would allow a customer to listen to music from a radio or a compact disc player for amusement as the customer's hair dries. Also, it could be sold as portable hairdryers and used in the homes by bored housewives to dry their hair.

2. Prior Art

In the past, when customers would go into a styling salon to get their hair cut or styled, it would be first washed in a sink, and then dried through the use of a hair dryer chair with a hood that fit over the head. However, using the chair style hair dryer can be boring for many people.

Some salons have tried to alleviate the problem by playing loud music over the intercom to drown out the noise of the hairdryer, as well as entertain the customer. Since every individual is different and have their own special taste in music, this can sometime be quite distracting and even sometimes irritating.

No device is known, however, that would make getting your hair dried, a personal entertaining experience as with the Radio/CD Player Drying Hood.

### SUMMARY OF THE INVENTION

The principle object of the Radio/CD Player Hair Drying Hood is to provide the public with a way to be entertained while drying their hair. A task that have proven to be be very boring in the past. The compact disc player can be used to play music or listen to other enlightened presentations. Even study tapes for school or programs.

It is also an object of the present invention to provide such a device, which is of simple, inexpensive construction. The components of Radio/CD Player Drying Hood utilize standard production technology. No new research or development in this area is anticipated, nor is major retooling or materials expense expected. In effect, this provides the company with lower start up costs, which is a major consideration for product development.

Another object is to provide a product that is environmental safe. Companies, especially in the beauty salon equipment industry, are very cautious when it come to using products that are not environmentally approved. The Radio/CD Playing Drying Hood would drown out the noise of the blower, which is right in your ears, and replace the noise with entertainment.

The foregoing objects can be accomplished by the use of metal, plastic, electrical components, and electronic components as its major components. The Radio/CD Player Dryer Hood would consist of a multi-component entertainment system. One component would be in the form of a large, rounded hood for a salon chair. The hood would be molded from plastic and would contain three to four loudspeakers. The speakers would be wired to a plastic/metal CD player and AM/FM radio, fitted into one of the of the armrests of a salon chair. The CD player and radio would be powered through the use of a battery compartment with metal contacts or by a power cord.

### BRIEF DESCRIPTION OF THE DRAWINGS

FIG. 1 is the drawing of a salon chair which supports the large rounded hood that contains the speakers which would provide the entertainment while a customer hair is being dried.

FIG. 2 is the radio/CD player, which would be attached to the armrests of the chair.

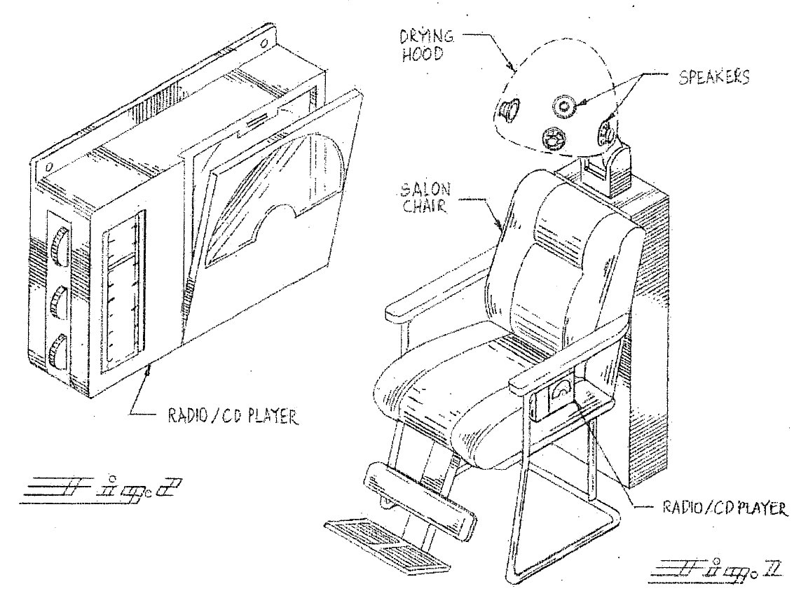

### DETAILED DESCRIPTION

The plastic components of Radio/CD Player Drying Hood could be formed with the use of plastic molding techniques such as injection molding or blow molding. Injection molding is a process that has been in use since the 1920s and provides versatility almost unmatched in the mass production of any material. It requires that melted plastic be forcefully injected into relatively cool molds. As the plastic begins to harden, it takes on the shape of the mold cavity and, when cool, requires few post molding operations. Other advantages of this process include its speed of production and its ability to allow multiple parts to be simultaneously molded.

Blow molding in the production of plastic shapes is a form of extrusion, a major technique in the plastic industry. Extrusion is used to push a molten tube, called a parison, into a bottle shaped mold. Compressed air then forces the parison against the cold walls of the mold, called “blow molding”.

The hood would be molded from plastics and contain three to four loudspeakers. The speakers would be placed in a manner to provide surround sound in a state of the art manner. In a portable dryer the speakers would be wired to a plastic/metal CD player and AM/FM radio, and fitted in the base of the unit. In a salon chair the speakers would be wired to a plastic/metal CD player and AM/FM radio, and fitted into one of the armrests of the salon chair. The CD player and radio would be powered through the use of a battery compartment with metal contacts or by a power cord.

The metal components of Radio/CD Player Drying Hood might be manufactured from Type 303 or 304 stainless steel. Common physical characteristics of these metals are good to high tensile strength and good to high corrosion resistance.

The plastic components of Radio/CD Player Drying Hood could be created from PVC, ABS, polycarbonate or polyurethane plastic. These plastics would be suitable for use with Radio/CD Player Drying Hood, since they would be durable, strong, lightweight and relatively inexpensive to use.

The design of Radio/CD Player Drying Hood calls for metal, plastic, electrical components and electronic components to be utilized as its major components. Radio/CD Player Drying Hood would consist of a multi-component entertainment center that would entertain you while you dry your hair. There would be three to four speakers wired to the plastic hood.

I claim:

1. A Radio/CD Player Drying Hood for use to entertain while drying the hair Comprising of metal, plastic, electrical components and electronic components as its major components all working together, the plastic molding formulated through either injection molding or blow molding, a form of extrusion, would contain three to four loudspeakers wired to a plastic/metal CD Player and AM/FM radio and fitted to the base of the unit or fitted to the armrest of a salon chair and powered through the use of a battery compartment with metal contacts or by a power cord.
